(19) United States
(12) Patent Application Publication
(10) Pub. No.: US 2020/0114399 A1
(43) Pub. Date: Apr. 16, 2020

(54) Glass cleaning apparatus with sterilization and degreasing function

(71) Applicant: Xiaoping Shuai, Tianjin City (CN)

(72) Inventor: Xiaoping Shuai, Tianjin City (CN)

(21) Appl. No.: 16/716,496

(22) Filed: Dec. 17, 2019

(30) Foreign Application Priority Data
Sep. 28, 2019 (CN) 2019109287940

(51) Int. Cl. B08B 3/08; B08B 3/02; B08B 1/00

(52) U.S. Cl. CPC B08B 3/08; B08B 1/002; B08B 3/026

(57) ABSTRACT

The invention discloses a glass cleaning apparatus with sterilization and degreasing function, and includes a fuselage and an operating cavity provided in the fuselage, a fixed cavity communicating with the outside is provided in a left end wall of the operating cavity, and a sliding frame is slidably disposed in the operating cavity. The left end of the sliding frame A first sliding cavity with an opening to the left is provided in the wall. The glass cleaning device provided with sterilizing and degreasing functions provided by the present invention can realize automatic cleaning and disinfection of glass. The device of the present invention first sprays the glass surface during cleaning. Drain the heated cleaning and disinfecting solution. The heated cleaning and disinfecting solution has stronger enzyme activity and better cleaning effect. At the same time, there are two rows of cleaning wheels distributed in a straight line in the device.

### CROSS-REFERENCES TO RELATED APPLICATIONS

The present application claims priority from Chinese application No. 2019109287940 filed on Sep. 28, 2019 which is hereby incorporated by reference in its entirety.

### FIELD OF TECHNOLOGY

The invention relates to the field of cleaning equipment, and in particular relates to a glass cleaning apparatus with sterilization and degreasing function.

### TECHNICAL FIELD

When people are cleaning glass, especially when it is stained with oily glass, the oily stain is too stubborn, which leads to dirty cleaning and incomplete disinfection. In addition, the traditional glass cleaning has a single rotation of the rotating wheel during cleaning. The cleaning wheel cannot be moved automatically during cleaning, resulting in a narrow equipment cleaning range and low cleaning efficiency. Therefore, it is necessary to set up a glass cleaning device with a sterilizing and degreasing function to improve the above problems.

### CONTENT OF THE INVENTION

The object of the present invention is to provide a glass cleaning device with a sterilization and degreasing function, which can overcome the above-mentioned defects of the prior art, thereby improving the practicability of the equipment.

The technical solution adopted by the present invention to solve its technical problems is that the glass cleaning device with sterilization and degreasing function of the present invention includes a fuselage and an operating cavity provided in the fuselage, and a left end wall of the operating cavity A fixed cavity communicating with the outside is provided therein, and a sliding frame is slidably disposed in the operating cavity. A first sliding cavity opening to the left is provided in the left end wall of the sliding frame, and the first sliding cavity may be A first sliding block is provided to slide up and down, and a first sliding hole penetrating up and down is symmetrically provided in the first sliding block. A first sliding rod extending up and down is slidably connected to the first sliding hole. The upper and lower ends of a sliding rod are fixedly connected to the upper and lower end walls of the first sliding cavity. A left end wall of the first sliding block is provided with a worm gear cavity, and a cleaning device is provided in the worm gear cavity. A plurality of vertically symmetrical cleaning brushes arranged on the left side of the first sliding block are driven to rotate, thereby realizing the cleaning of the glass. A second sliding cavity is provided in the right end wall of the first sliding block, and the second Sliding cavity A second sliding block is slidably provided, and the second sliding block moves to drive the cleaning device. A switching cavity is provided in the rear end wall of the first sliding cavity, and the first sliding cavity and the A first rotating shaft is rotatably provided between the switching cavities, a first bevel gear is fixedly provided at the end of the first rotating shaft in the switching cavity, and a first bevel is fixedly provided at the end of the first rotating shaft in the first sliding cavity. A sprocket, a second symmetric sprocket is rotatably disposed in the rear end wall of the first sliding cavity, and the two front and rear second sprocket and the first sprocket are connected by a chain transmission A second rotating shaft fixedly connected to the chain is provided in the rear end wall of the second sliding block, and when the chain rotates, the second rotating shaft is driven to move, thereby driving the second sliding block to move. The movement of the second sliding block can drive the first sliding block to move up and down. A lifting device for moving the sliding frame up and down is provided in the switching cavity, and the lifting device utilizes a penetrating mechanism provided in the sliding frame to rotate. Descrição The threaded sleeve rotates to move up and down along a threaded rod that is threadedly connected to the internally threaded hole of the threaded sleeve. The threaded rod is fixedly disposed between the upper and lower end walls of the first sliding cavity, and is disposed in the left end wall of the switching cavity. There is a third sliding cavity. A cam cavity is provided in the top wall of the third sliding cavity. A disinfection device is provided between the cam cavity and a compression cavity provided in the left end wall of the sliding frame. The disinfection cleaning solution contained in the squeeze cavity can be sprayed on the glass surface, and the oil stain on the glass surface can be removed and disinfected at the same time after the cleaning device acts. A power device is provided in the third sliding cavity. The power device can provide power to the lifting device and the rotation of the chain.

Further, the cleaning device includes a plurality of third rotating shafts fixedly connected to the cleaning brush and arranged in the left end wall of the worm gear cavity, and a worm gear is fixedly arranged at the end of the cleaning brush in the worm gear cavity, A belt cavity is provided in the front end wall of the first sliding block, and a worm is engaged between the belt cavity and the worm wheel cavity to engage with the worm wheel provided in the worm wheel cavity. A first pulley is fixedly arranged at the end of the worm.

Further, a transmission cavity is provided in the second sliding block, and a spline sleeve is rotatably provided in the transmission cavity, and spline holes penetrating back and forth are provided in the spline sleeve. A spline shaft extending back and forth is connected to the spline. The front side of the spline shaft extends into the belt cavity and a second pulley is fixedly arranged at the end. The second pulley is between the second pulley and the first pulley. Connected by a belt drive, a fourth rotation shaft is rotatably disposed in the left end wall of the transmission cavity, and a second rotation shaft is fixedly disposed at the end of the fourth rotation shaft in the transmission cavity. A third bevel gear meshed with a bevel gear, a left end of the fourth rotation shaft is fixedly provided with a gear meshing with a rack fixedly disposed on a bottom wall of the second sliding cavity.

Further, the lifting device includes a fourth bevel gear fixedly disposed on the outer surface of the threaded sleeve in the switching cavity, and a second sliding hole penetrating up and down is symmetrically provided in the sliding frame in front and back, and the second sliding A second sliding rod extending up and down is slidably connected in the hole, and the upper and lower ends of the second sliding rod are fixedly disposed on the upper and lower end walls of the operating cavity.

Further, the disinfection device includes a third sliding hole symmetrically disposed in the upper and lower end walls of the cam cavity, a third sliding rod is slidably disposed in the third sliding hole, and an end wall of the third sliding hole is disposed in the third sliding hole. A resetting device is provided to drive the third sliding hole to move backward after the third sliding hole is moved, and a hydraulic hole communicating with the third sliding hole above is provided in the squeeze cavity. A push rod is slidably provided in the hole, and the push rod is fixedly connected to a slidable push block provided in the squeeze cavity. A first motor is fixedly disposed in the right end wall of the cam cavity. A cam is fixedly arranged at the end of a motor output shaft.

Further, spray holes communicating with the outside are uniformly distributed in the left end wall of the squeeze cavity, and a liquid storage cavity is provided in the top wall of the operation cavity, and the liquid storage cavity communicates with the squeeze cavity. A communication pipe is provided.

Further, the power device includes a third sliding block slidably disposed in the third sliding cavity, the third sliding block is fixedly connected with the third sliding rod below, and the third sliding block is right A second motor is disposed in the side end wall, and a fifth bevel gear meshing with the first bevel gear is fixedly disposed at the end of the second motor output shaft.

Further, a fixing groove with an upward opening is provided in the bottom wall of the fixing cavity, and a clamping groove corresponding to the fixing groove is provided in the opening in the top wall of the fixing cavity, and a compressible groove is provided in the fixing groove. Compressed blocks.

Further, a heating device is fixedly arranged in the left end wall of the pushing block, and the heating device can heat the disinfection and cleaning liquid in the squeeze cavity, so that the cleaning effect is better.

Beneficial effects of the present invention: A glass cleaning device with sterilization and degreasing function provided by the present invention can realize automatic cleaning and disinfection of glass. The device of the present invention sprays and heats the cleaning and disinfecting liquid on the glass surface during cleaning first. The heated cleaning and disinfecting solution has stronger enzyme activity and better cleaning effect. At the same time, two rows of cleaning wheels distributed in a straight line are set in the device. The device drives the cleaning wheel to rotate in different directions to remove stubborn stains. At the same time, the device is on the cleaning wheel. Rotating at the same time drives its movement, achieving a wider range of cleaning and disinfection, and increasing equipment efficiency.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

The invention is further described below with reference to the drawings and embodiments.

FIG. 1 is a schematic diagram of the overall structure of a glass cleaning device with a sterilization and degreasing function according to the present invention.

FIG. 2 is a schematic structural diagram of A-A in FIG. 1.

FIG. 3 is a schematic structural diagram of B-B in FIG. 1.

FIG. 4 is an enlarged structural diagram of C in FIG. 1.

FIG. 5 is an enlarged structural diagram of D in FIG. 1.

### DETAILED DESCRIPTION OF THE INVENTION

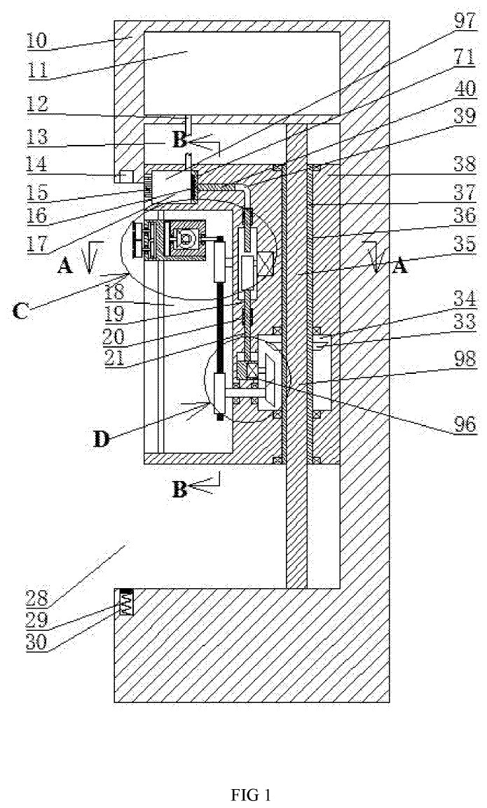

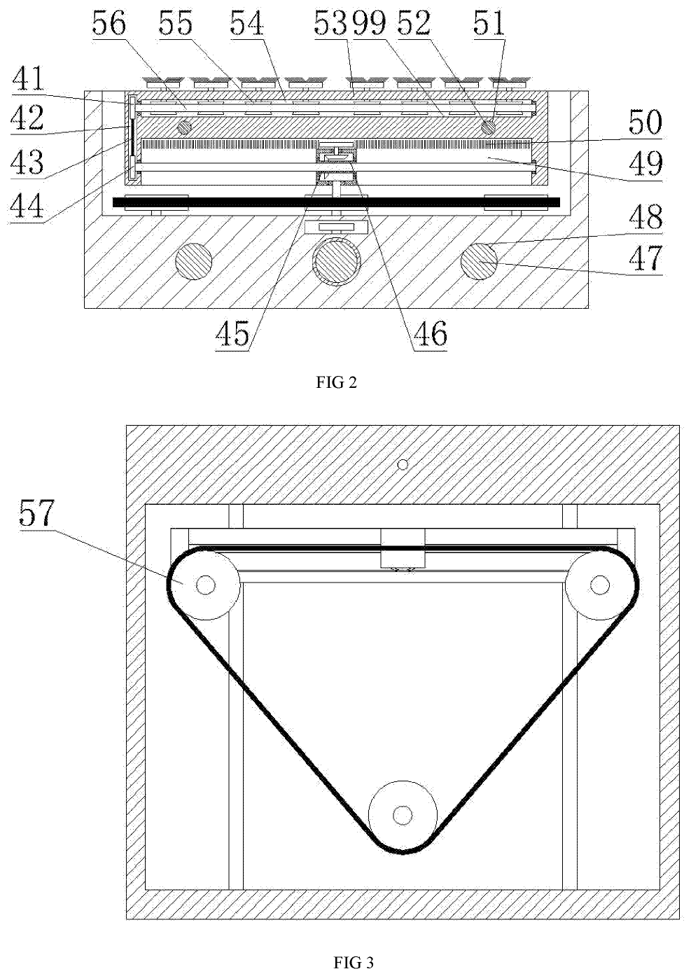

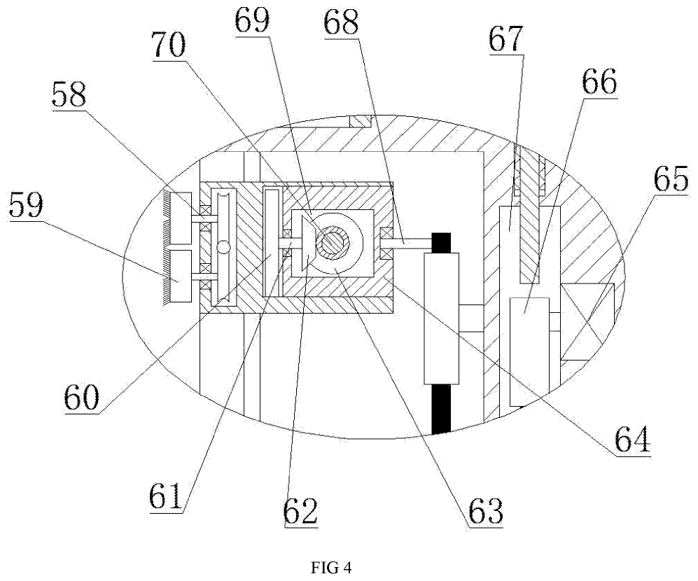

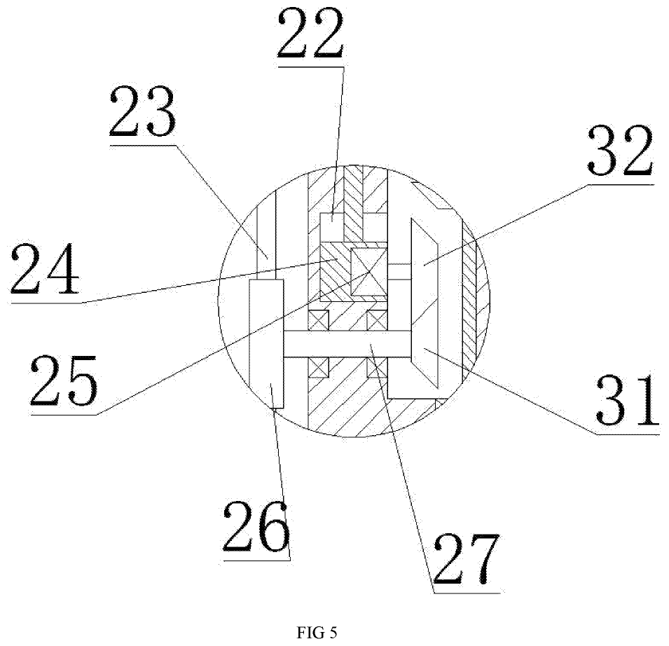

The present invention will be described in detail below with reference to FIGS. 1-5. Among them, for convenience of description, the orientation described below is specified as follows: the up-down, left-right, front-back direction described below is consistent with the up-down, left-right, front-back direction of the projection relationship of FIG.

A glass cleaning device with a sterilizing and degreasing function as described in conjunction with FIGS. 1-5 includes a main body 10 and an operation chamber 13 provided in the main body 10. A left end wall of the operation chamber 13 is provided in the side wall. A fixed cavity 28 communicating with the outside, a sliding frame 38 is slidably disposed in the operation cavity 13, and a first sliding cavity 18 opening to the left is provided in a left end wall of the sliding frame 38. A first sliding block 53 is slidably arranged in 18, and a first sliding hole 51 penetrating up and down is symmetrically provided in the first sliding block 53. The first sliding hole 51 is slidably connected with the first and second extending holes. A sliding rod 52 is provided. The upper and lower ends of the first sliding rod 52 are fixedly connected to the upper and lower end walls of the first sliding cavity 18. A left end wall of the first sliding block 53 is provided with a worm wheel cavity 54. A cleaning device 99 is provided in the worm wheel cavity 54, and the cleaning device 99 drives the plurality of vertically symmetrical cleaning brushes 59 that are arranged on the left side of the first sliding block 53 to rotate, thereby realizing the cleaning of the glass. A second sliding cavity 49 is provided in the right end wall of the block 53. A second sliding block 64 is slidably provided in the cavity 49, and the second sliding block 64 can move the cleaning device 99 to move. A switching cavity 34 is provided in the rear end wall of the first sliding cavity 18. A first rotating shaft 27 is rotatably provided between the first sliding cavity 18 and the switching cavity 34, and a first bevel gear 31 is fixedly disposed at the end of the first rotating shaft 27 in the switching cavity 34. A first sprocket 26 is fixedly disposed at the end of the first rotating shaft 27 in the cavity 18, and a second sprocket 57 is rotatably provided in the rear end wall of the first sliding cavity 18. The second sprocket 57 and the first sprocket 26 are driven and connected by a chain 23, and a second rotating shaft 68 fixedly connected to the chain 23 is rotatably provided in the rear end wall of the second sliding block 64. When the chain 23 rotates, the second rotating shaft 68 is driven to move, thereby driving the second sliding block 64 to move. The movement of the second sliding block 64 can cause the first sliding block 53 to move up and down. The switching The cavity 34 is provided with a lifting device 98 which drives the sliding frame 38 to move up and down. The position 98 is rotated by using a threaded sleeve 37 penetrating through the slide frame 38 inside the slide frame 38, so as to move up and down along a threaded rod 35 that is threadedly connected to the internally threaded hole 36 of the threaded sleeve 37. It is fixedly arranged between the upper and lower end walls of the first sliding cavity 18, a third sliding cavity 22 is disposed in the left end wall of the switching cavity 34, and a cam cavity 67 is disposed in the top wall of the third sliding cavity 22. A disinfection device 97 is provided between the cam cavity 67 and the squeeze cavity 17 provided in the left end wall of the sliding frame 38, and the disinfection device 97 can spray the disinfection cleaning solution contained in the squeeze cavity 17 It is showered on the glass surface, and the oil stain on the glass surface is removed and disinfected at the same time after the action of the cleaning device 99. The third sliding chamber 22 is provided with a power device 96, which can be the lifting device. 98 and the rotation of the chain 23 provides power.

Advantageously, the cleaning device 99 includes a plurality of third rotating shafts 58 fixedly connected to the cleaning brush 59 in the left end wall of the worm wheel cavity 54, and the cleaning brush 59 in the worm wheel cavity 54. A worm gear 55 is fixedly arranged at the end, and a belt cavity 42 is provided in the front end wall of the first sliding block 53. The belt cavity 42 and the worm gear cavity 54 are rotatably provided to rotate with the worm gear cavity 54. The worm gears 55 are all meshed with a worm 56, and a first pulley 41 is fixed at the end of the worm 56 in the belt cavity 42.

Beneficially, a transmission cavity 69 is provided in the second sliding block 64, and a spline sleeve 45 is rotatably provided in the transmission cavity 69. A spline hole 46 penetrating back and forth is provided in the spline sleeve 45. A spline shaft 70 extending back and forth is splined in the spline hole 46. A front side of the spline shaft 70 extends into the belt cavity 42 and a second pulley 44 is fixed at the end. The pulley 44 and the first pulley 41 are driven and connected by a belt 43. A fourth rotation shaft 61 is rotatably provided in the left end wall of the transmission cavity 69, and the fourth rotation shaft in the transmission cavity 69 A third bevel gear 62 meshed with a second bevel gear 63 fixedly disposed on the outer surface of the spline sleeve 45 is fixedly provided at the end of the 61, and a left side end of the fourth rotation shaft 61 is fixedly provided with the second sliding cavity 49. A gear 60 meshed with a rack 50 is fixed on the bottom wall.

Beneficially, the lifting device 98 includes a fourth bevel gear 33 fixedly disposed on the outer surface of the threaded sleeve 37 in the switching cavity 34, and a second sliding hole 48 penetrating up and down is symmetrically provided in the sliding frame 38 in the front and rear. The second sliding hole 48 is slidably connected with the second sliding rod 47 extending up and down, and the upper and lower ends of the second sliding rod 47 are fixedly disposed on the upper and lower end walls of the operating cavity 13.

Beneficially, the disinfection device 97 includes a third sliding hole 19 symmetrically disposed in the upper and lower end walls of the cam cavity 67, and a third sliding rod 21 is slidably disposed in the third sliding hole 19, and the third A reset device 20 is provided in the end wall of the sliding hole 19 to drive the third sliding hole 19 to move backward after the third sliding hole 19 is moved. The pressing cavity 17 is provided with the third third A hydraulic hole 39 communicated with the sliding hole 19, a push rod 40 is slidably disposed in the hydraulic hole 39, and the push rod 40 is fixedly connected to a push block 16 slidably disposed in the squeeze cavity 17. A first motor 65 is fixedly disposed in the right end wall of the cam cavity 67, and a cam 66 is fixedly disposed at the end of the output shaft of the first motor 65.

Beneficially, a spray hole 15 communicating with the outside is uniformly distributed in the left end wall of the squeeze cavity 17, and a liquid storage cavity 11 is provided in the top wall of the operation cavity 13. A communication pipe 12 is provided in communication between the pressure chambers 17.

Advantageously, the power device 96 includes a third sliding block 24 slidably disposed in the third sliding cavity 22, and the third sliding block 24 is fixedly connected to the third sliding rod 21 below. A second motor 25 is disposed in the right end wall of the third sliding block 24, and a fifth bevel gear 32 meshing with the first bevel gear 31 is fixedly disposed at the end of the output shaft of the second motor 25.

Beneficially, a fixing groove 30 with an upward opening is provided in a bottom wall of the fixing cavity 28, and a locking groove 14 corresponding to the fixing groove 30 is provided in an opening in the top wall of the fixing cavity 28. The fixing groove 30 A compressible compression block 29 is provided therein.

Beneficially, a heating device 71 is fixedly disposed in the left end wall of the pushing block 16, and the heating device 71 can heat the disinfection cleaning liquid in the squeeze cavity 17, so that the cleaning effect is better.

The fixed connection method described in this embodiment includes, but is not limited to, methods such as bolt fixing and welding.

As shown in FIGS. 1-5, in the initial state of the device of the present invention, the slide frame 38 is located above the operation cavity 13, the third slide block 24 is located below the third slide cavity 22, and the fifth cone The gear 32 meshes with the first bevel gear 31, and the fifth bevel gear 32 is separated from the fourth bevel gear 33.

The sequence of mechanical actions of the entire device:

1. When the device of the present invention is working, hold the glass on both sides, tilt the glass to the left, insert the bottom into the fixing groove 30, compress the compression block 29 downward, and then align the top of the glass with the card slot 14. At this time, the compression block 29 pushes the glass into the card slot 14, and the glass is fixed at this time, and the glass abuts the cleaning brush 59, and the first motor 65 is started to drive the cam 66 to rotate once. The rotation of the cam 66 drives the third sliding rod 21 above to move upward, thereby pushing the push rod 40 to the left by squeezing the hydraulic oil in the hydraulic hole 39, thereby driving the second sliding rod 47 The disinfection cleaning liquid heated by the heating device 71 is sprayed on the glass surface through the spray hole 15, and then the push rod 40 moves backward to drive the push block 16 to the right to reset;

2. At this time, the second motor 25 is started to drive the fifth bevel gear 32 to rotate, thereby driving the fifth bevel gear 32 to rotate, thereby driving the first bevel gear 31 to rotate, thereby driving the first chain. The wheel 26 rotates, thereby driving the chain 23 to rotate. The rotation of the chain 23 causes the second rotating shaft 68 to move, thereby driving the second sliding block 64 to move. When the second sliding block 64 moves, the gear 60 Rotate under the action of the cleaning brush 59, thereby driving the third bevel gear 62 to rotate, thereby driving the second bevel gear 63 to rotate, thereby driving the spline sleeve 45 to rotate, thereby driving the spline shaft 70 Rotate, thereby driving the second pulley 44 to rotate, thereby driving the first pulley 41 to rotate, thereby driving the worm 56 to rotate, and the worm 56 rotating to rotate the upper and lower two groups of the worm gear 55, thereby driving all The cleaning brush 59 rotates to clean the glass;

3. As the chain 23 rotates, the second rotating shaft 68 moves downwards, thereby driving the first sliding block 53 to move downward. At this time, the cleaning brush 59 rotates and moves down with the second rotating shaft 68 After the cleaning, the first motor 65 is started to drive the cam 66 to rotate for half a turn. At this time, the third sliding block 24 is moved up to drive the fifth bevel gear 32. And meshing with the fourth bevel gear 33 while the fifth bevel gear 32 is separated from the first bevel gear 31, at this time, the second motor 25 is started to drive the fifth bevel gear 32 to rotate, thereby driving The fourth bevel gear 33 rotates, thereby driving the threaded sleeve 37 to rotate, thereby driving the sliding frame 38 to move down the threaded rod 35. At this time, the above operation is repeated to facilitate cleaning of the lower half of the glass.

The above embodiments are only for explaining the technical concept and characteristics of the present invention, and the purpose thereof is to enable those skilled in the art to understand and implement the content of the present invention, but not to limit the protection scope of the present invention. All equivalent changes or modifications made according to the spirit of the present invention shall be covered by the protection scope of the present invention.

1. A glass cleaning apparatus with sterilization and degreasing function includes a fuselage and an operating cavity provided in the fuselage. A fixed cavity communicating with the outside is provided in a left end wall of the operating cavity, and the operating cavity is slidable. A sliding frame is provided, and a first sliding cavity opening to the left is provided in the left end wall of the sliding frame, and a first sliding block is slidably arranged in the first sliding cavity. The first sliding block A first sliding hole penetrating up and down is symmetrically arranged in the front and back. The first sliding hole is slidably connected with a first sliding rod extending up and down. The upper and lower ends of the first sliding rod and the upper and lower ends of the first sliding cavity are slidably connected. The wall is fixedly connected, and a worm wheel cavity is provided in the left end wall of the first sliding block. A cleaning device is provided in the worm wheel cavity. The cleaning device drives the left side of the first sliding block to be rotated symmetrically. The cleaning brushes of the group are rotated to clean the glass. A second sliding cavity is provided in the right end wall of the first sliding block, and a second sliding block is slidably provided in the second sliding cavity. Two sliding block movement energy To drive the cleaning device to move, a switching cavity is provided in the rear end wall of the first sliding cavity, and a first rotating shaft is rotatably provided between the first sliding cavity and the switching cavity. A first bevel gear is fixedly provided at the end of the first rotating shaft, a first sprocket is fixedly provided at the end of the first rotating shaft in the first sliding cavity, and a rotatable setting is provided in the rear end wall of the first sliding cavity. a second sprocket with front-to-back symmetry is connected between the two front and rear second sprocket wheels and the first sprocket through a chain transmission. a rear end wall of the second sliding block is arranged to rotate with the second sprocket. a second rotating shaft fixedly connected to the chain, when the chain rotates, the second rotating shaft is moved, thereby driving the second sliding block to move, and the second sliding block movement can drive the first sliding block to move up and down, so The switching cavity is provided with a lifting device for driving the sliding frame to move up and down. The lifting device rotates through a threaded sleeve provided in the sliding frame and penetrating the sliding frame, so as to rotate along the internal thread hole of the threaded sleeve. Threaded connection The threaded rod moves up and down, the threaded rod is fixedly arranged between the upper and lower end walls of the first sliding cavity, a third sliding cavity is provided in the left end wall of the switching cavity, and a top wall of the third sliding cavity is provided A cam cavity, a disinfection device is provided between the cam cavity and the extrusion cavity provided in the left end wall of the sliding frame, and the disinfection device can spray the disinfection cleaning liquid contained in the extrusion cavity on The glass surface is sterilized while removing oil stains on the glass surface after the cleaning device functions. The third sliding chamber is provided with a power device, which can be used for rotation of the lifting device and the chain. Provide power.

2. The glass cleaning apparatus with sterilization and degreasing function according to claim 1, wherein the cleaning device comprises a plurality of first rotatingly disposed in the left end wall of the worm wheel cavity and fixedly connected to the cleaning brush. Three rotation shafts, a worm gear is fixedly arranged at the end of the cleaning brush in the worm gear cavity, a belt cavity is arranged in the front end wall of the first sliding block, and a rotation is provided between the belt cavity and the worm gear cavity. A worm is engaged with the worm wheels that are rotatably arranged in the worm wheel cavity, and a first pulley is fixedly disposed at the end of the worm in the belt cavity.

3. The glass cleaning apparatus with sterilization and degreasing function according to claim 2, wherein a transmission cavity is provided in the second sliding block, and a spline sleeve is rotatably disposed in the transmission cavity, and The spline sleeve is provided with a spline hole penetrating back and forth. The spline hole is splined with a spline shaft extending forward and backward. The front side of the spline shaft extends into the belt cavity and the end is fixedly provided with a cap. Two pulleys, the second pulley and the first pulley are connected by a belt transmission, a fourth shaft is rotatably provided in the left end wall of the transmission cavity, and the first A third bevel gear meshing with a second bevel gear fixedly disposed on the outer surface of the spline sleeve is fixedly disposed at the end of the four rotation shafts, and a left end of the fourth rotation shaft is fixedly fixedly fixed to the bottom wall of the second sliding cavity. Set of rack gears meshing.

4. The glass cleaning apparatus with sterilization and degreasing function according to claim 1, wherein the lifting device comprises a fourth bevel gear fixedly disposed on the outer surface of the threaded sleeve in the switching cavity, and the slide A second sliding hole penetrating up and down is symmetrically provided in the frame in a forward-backward direction, and a second sliding rod extending up and down is slidably connected in the second sliding hole, and the upper and lower ends of the second sliding rod are fixedly arranged above and below the operating cavity.

5. The glass cleaning apparatus with sterilization and degreasing function according to claim 1, wherein the disinfection device comprises a third sliding hole symmetrically arranged in the upper and lower end walls of the cam cavity, and the third sliding hole A third sliding rod is slidably provided, and a reset device for driving the third sliding hole to move backward after the third sliding hole is moved is disposed in the end wall of the third sliding hole, and the squeeze cavity A hydraulic hole communicating with the third sliding hole above is provided, and a push rod is slidably arranged in the hydraulic hole, and the push rod is fixedly connected with a slidably arranged push block in the squeeze cavity. A first motor is fixedly disposed in the right end wall of the cam cavity, and a cam is fixedly disposed at the end of the first motor output shaft.

6. The glass cleaning apparatus with sterilization and degreasing function according to claim 5, wherein the left end wall of the squeeze cavity is evenly distributed with spray holes communicating with the outside, and the top wall of the operation cavity is provided A liquid storage cavity is provided, and a communication tube is provided between the liquid storage cavity and the squeeze cavity.

7. The glass cleaning apparatus with sterilization and degreasing function according to claim 1, wherein the power device comprises a third sliding block slidably disposed in the third sliding cavity, and the third sliding block It is fixedly connected with the third sliding rod below. A second motor is disposed in the right end wall of the third sliding block. The end of the second motor output shaft is fixedly provided with a first meshing mesh with the first bevel gear. Five bevel gear.

8. The glass cleaning apparatus with sterilization and degreasing function according to claim 1, wherein a fixed groove with an upward opening is provided in the bottom wall of the fixed cavity, and an internal opening with a downward opening is provided in the top wall of the fixed cavity. A clamping groove corresponding to the fixing groove, and a compressible compression block is disposed in the fixing groove.

9. The glass cleaning apparatus with sterilization and degreasing function according to claim 5, characterized in that: a heating device is fixedly arranged in the left end wall of the pushing block, and the heating device can sterilize the squeeze cavity The cleaning liquid is heated for better cleaning results.
